(19) United States
(12) Patent Application Publication
(10) Pub. No.: US 2012/0174626 A1
(43) Pub. Date: Jul. 12, 2012

(54) JEWELRY SYSTEM WITH INTERCHANGEABLE ELEMENTS

(76) Inventors: Kara L. Larson, Charlotte, NC (US); Catherine W. Hines, Charlotte, NC (US)

(21) Appl. No.: 13/324,122

(22) Filed: Dec. 13, 2011

Related U.S. Application Data
(60) Provisional application No. 61/423,295, filed on Dec. 15, 2010.

(51) Int. Cl. A44C 5/22; G09F 3/02; G09F 3/00

(52) U.S. Cl. 63/3.1; 40/299.01

(57) ABSTRACT

A jewelry system comprises a main strand and at least one harmonizing strand. The main strand has a supporting string, first and second clasps, and a first bead pattern and second bead pattern each including at least one signature bead that identifies a theme of the jewelry system. The at least one harmonizing strand has a supporting string, first and second clasps, and a harmonizing bead pattern including at least one signature bead that corresponds to the theme of the jewelry system. In this manner, the multiple strands are conducive for trading and collecting among members of a social category or environment.

### RELATED APPLICATIONS

The application claims the benefit of U.S. Provisional Patent Application Ser. No. 61/423,295, filed Dec. 15, 2010, the content of which is incorporated herein by reference, in its entirety.

### FIELD

Embodiments relate generally to a multiple-element jewelry system, and, in particular, a multiple-element jewelry system that can be worn in a variety of ways. For example, elements of a system can be combined to be worn as a choker, a necklace, a bracelet, an anklet, a ponytail holder, and a head band. Further, elements of the system are constructed and arranged to be readily exchangeable with elements of other systems.

### SUMMARY

Embodiments disclosed herein provide a modular jewelry system including multiple attachable elements that can be arranged in a variety of configurations.

Embodiments disclosed herein further provide a jewelry system wherein the multiple elements are conducive for trading and collecting among members of a social category or environment.

In one aspect, a jewelry system comprises: a main strand having a supporting string, a first clasp at a first end of the supporting string and a second clasp at a second end of the supporting string opposite the first end, the main strand having a first bead pattern between the first clasp and a mid-position of the supporting string and having a second bead pattern between the second clasp and the mid-position of the supporting string, the first bead pattern and the second bead pattern each including at least one signature bead that identifies a theme of the jewelry system; and at least one harmonizing strand, each of the at least one harmonizing strands having a supporting string, a first clasp at a first end of the supporting string and a second clasp at a second end of the supporting string opposite the first end, the at least one harmonizing strand having a harmonizing bead pattern, the harmonizing bead pattern including at least one signature bead that corresponds to the theme of the jewelry system; wherein the first and second clasps of the main strand and the at least one harmonizing strand are constructed and arranged so that the first clasp of the main strand can be selectively connected to the second clasp of the at least one harmonizing strand, and so that the second clasp of the main strand can be connected to the first clasp of the at least one harmonizing strand.

In some embodiments, first and second clasps of the main strand and the harmonizing strand are constructed and arranged so that the first clasp of the main strand can be selectively connected to the second clasp of the main strand, and so that the first clasp of the at least one harmonizing strand can be connected to the second clasp of the at least one harmonizing strand.

In some embodiments, the first clasp comprises a male clasp and the second clasp comprises a female clasp.

In some embodiments, the male clasp comprises a male thread and the female clasp comprises a mating female thread.

In some embodiments, the at least one signature bead of the at least one harmonizing strand comprises a single signature bead that is positioned at a mid-position of the supporting string of the at least one harmonizing strand.

In some embodiments, the main strand further comprises a pendant positioned at the mid-position of the supporting string of the main strand.

In some embodiments, the pendant includes indicia that corresponds to the theme of the jewelry system.

In some embodiments, the indicia comprises an inspirational message.

In some embodiments, the pendant comprises a clasp that removably secures the pendant to the main strand.

In some embodiments, each of the first clasps comprises a hollowed body having a male thread projecting therefrom, the hollowed body having an opening extending along a longitudinal axis thereof.

In some embodiments, each of the second clasps comprises a hollowed body having a female thread portion corresponding to the male thread of the first clasps, the hollowed body having an opening extending along a longitudinal axis thereof.

In some embodiments, the openings of the hollowed bodies of the female and male clasps each further comprise a chamber that accommodates a knotted end of the supporting string, wherein the chamber is of an inner dimension to permit the knotted end to turn within the chamber.

In some embodiments, the first and second clasps each comprise indicia on an outer surface thereof.

In some embodiments, the indicia comprise a raised surface on the outer surface.

In some embodiments, the supporting string of the main strand and the auxiliary strand is longitudinally elastic.

In some embodiments, the first and second bead patterns of the main strand further comprise at least one bead selected from the group consisting of: a unity bead, an accent bead, and a spacer bead.

In some embodiments, the harmonizing beads of a same jewelry system comprise at least one of a substantially similar shape, a substantially similar size and a substantially similar color arrangement, and a substantially similar pattern.

In some embodiments, the at least one harmonizing strand comprises a single harmonizing strand.

In some embodiments, the at least one harmonizing strand comprises two harmonizing strands.

In an aspect, an interchangeable jewelry system, comprises a first jewelry system element comprising: a main strand having a supporting string, a first clasp at a first end of the supporting string and a second clasp at a second end of the supporting string opposite the first end, the main strand having a first bead pattern between the first clasp and a mid-position of the supporting string and having a second bead pattern between the second clasp and the mid-position of the supporting string, the first bead pattern and the second bead pattern each including at least one signature bead that identifies a first theme of the first jewelry system; and at least one harmonizing strand, each of the at least one harmonizing strands having a supporting string, a first clasp at a first end of the supporting string and a second clasp at a second end of the supporting string opposite the first end, the at least one harmonizing strand having a harmonizing bead pattern, the harmonizing bead pattern including at least one signature bead that corresponds to the first theme of the first jewelry system element; wherein the first and second clasps of the main strand and the at least one harmonizing strand are constructed and arranged so that the first clasp of the main strand can be selectively connected to the second clasp of the at least one harmonizing strand, and so that the second clasp of the main strand can be connected to the first clasp of the at least one harmonizing strand. A second jewelry system element comprises: a main strand having a supporting string, a first clasp at a first end of the supporting string and a second clasp at a second end of the supporting string opposite the first end, the main strand having a first bead pattern between the first clasp and a mid-position of the supporting string and having a second bead pattern between the second clasp and the mid-position of the supporting string, the first bead pattern and the second bead pattern each including at least one signature bead that identifies a second theme of the second jewelry system element; and at least one harmonizing strand, each of the at least one harmonizing strands having a supporting string, a first clasp at a first end of the supporting string and a second clasp at a second end of the supporting string opposite the first end, the at least one harmonizing strand having a harmonizing bead pattern, the harmonizing bead pattern including at least one signature bead that corresponds to the second theme of the second jewelry system; wherein the first and second clasps of the main strand and the at least one harmonizing strand are constructed and arranged so that the first clasp of the main strand can be selectively connected to the second clasp of the at least one harmonizing strand, and so that the second clasp of the main strand can be connected to the first clasp of the at least one harmonizing strand. The first and second clasps of the main strand and the at least one harmonizing strand of the first jewelry system element and wherein the first and second clasps of the main strand and the at least one harmonizing strand of the second jewelry system element are constructed and arranged to selectively connect to each other among the first and second jewelry systems so that the main and at least one harmonizing strands of the first and second jewelry system elements are interchangeable.

In another aspect, a jewelry system comprises: a main strand having a string, a male clasp at one end of the string and a female clasp at the other hand of the string; and at least two harmonizing strands, each of the harmonizing strands having a string, a male clasp at one end of the string and a female clasp at the other end of the string; wherein the mail clasp of each strand can be selectively connected to the female clasp of the each strand or connected to the female clasp of another strand.

In some embodiments, the main strand further comprises a pendant clasp and a pendant attached thereto.

In some embodiments, the main strand further comprises at least one signature bead having an identification mark that represents an original owner of the main strand.

In some embodiments, the harmonizing strands comprise the same signature bead as the main strand.

In some embodiments, the male clasp comprises a barrel-shaped body, a conical shape body, and at least one raised emblem which covers a part of the barrel shape body and the conical shape body.

In some embodiments, the male clasp further comprises a chamber that accommodates a first knotted end of the elastic string and enables the knotted end to turn within the chamber.

In some embodiments, the chamber has an opening through which the elastic string can pass and the diameter of which is smaller than that of the knotted end of the elastic string.

In some embodiments, the female clasp comprises a barrel shape body, a conical shape body, and at least one raised emblem which covers a part of the barrel shape body and the conical shape body.

In some embodiments, the female clasp further comprises a chamber that accommodates a second knotted end of the elastic string and enables the knotted end to turn within the chamber.

In some embodiments, the chamber has an opening through which the elastic string can pass and the diameter of which is smaller than that of the knotted end of the elastic string.

In some embodiments, when the male clasp and female clasp are completely inter-engaged, the male clasp and the female clasp have at least one raised emblem on their respective surface.

### BRIEF DESCRIPTION OF THE DRAWINGS

The foregoing and other objects, features and advantages of the embodiments will be apparent from the more particular description of preferred embodiments of the inventive concept, as illustrated in the accompanying drawings in which like reference characters refer to the same parts throughout the different views. The drawings are not necessarily to scale, emphasis instead being placed upon illustrating the principles of the inventive concept. In the drawings:

FIG. 1 is a schematic illustration of a jewelry system in accordance with embodiments of the present inventive concepts.

FIG. 2A is a schematic illustration of a frame on which various kinds of beads can be strung, suitable for the main strand and the harmonizing strand as shown in FIG. 3 and FIG. 4, respectively, in accordance with embodiments of the present inventive concepts.

FIG. 2B is a plan view illustration of the inter-engaged state of a male end clasp and a female end clasp, in accordance with embodiments of the present inventive concepts.

FIG. 2C is a cross-sectional view taken at line X-Y of FIG. 2B, in accordance with embodiments of the present inventive concepts.

FIG. 3 is a schematic illustration of a main strand in accordance with embodiments of the present inventive concepts.

FIG. 4 is a schematic illustration of a harmonizing strand in accordance with embodiments of the present inventive concepts.

FIG. 5 is a schematic illustration of a modular jewelry system configured as a choker with pendant as worn around an individual's neck in accordance with embodiments of the present inventive concepts.

FIG. 6 is a schematic illustration of a modular jewelry system configured as a necklace with pendant worn around an individual's neck in accordance with embodiments of the present inventive concepts.

FIG. 7 is a schematic illustration of a modular jewelry system configured as a pony-tail holder, in accordance with embodiments of the present inventive concepts.

FIG. 8 is a schematic illustration of a pony-tail holder of the type shown in FIG. 7A being worn by an individual, in accordance with embodiments of the present inventive concepts.

FIG. 9 is a schematic illustration of a modular jewelry system configured as a headband, in accordance with embodiments of the present inventive concepts.

FIG. 10 is a schematic illustration of the headband of the type shown in FIG. 9 being worn by an individual, in accordance with embodiments of the present inventive concepts.

FIG. 11 is a perspective view of an embodiment of male and female end clasps, in accordance with embodiments of the present inventive concepts.

FIG. 12 includes views of an embodiment of a system illustrating an assembled top view, and including a disassembled side view of the main strand and first and second harmonizing strands, in accordance with embodiments of the present inventive concepts.

FIG. 13 includes a view of an embodiment of a system illustrating an assembled top view of the main strand and first and second harmonizing strands, in accordance with embodiments of the present inventive concepts.

FIG. 14 includes a view of an embodiment of a system illustrating an assembled top view of a main strand and a harmonizing strand, in accordance with embodiments of the present inventive concepts.

FIG. 14 includes a view of an embodiment of a system illustrating an assembled top view of a main strand and a harmonizing strand, in accordance with embodiments of the present inventive concepts.

FIG. 15 is a top view of the system of FIG. 14, with each of the first and second systems illustrated as comprising a main strand and first and second harmonizing strands, in accordance with embodiments of the present inventive concepts.

FIGS. 16A and 16B are top views of various pendants, each indicating an inspirational expression, in accordance with embodiments of the present inventive concepts.

FIG. 17 is a top view of the system of FIG. 15, with each of the first and second systems illustrated as comprising a main strand and first and second harmonizing strands, in accordance with embodiments of the present inventive concepts.

FIGS. 18 and 19 are top views of various systems in accordance with embodiments of the present inventive concepts.

FIG. 20 is a close-up view of the pendants of the main strands of various systems in accordance with embodiments of the present inventive concepts.

### DETAILED DESCRIPTION OF EMBODIMENTS

Embodiments of the present inventive concepts will now be described more fully hereinafter with reference to the accompanying drawings, in which preferred embodiments of the invention are shown. The invention may, however, be embodied in different forms and should not be construed as limited to the embodiments set forth herein. Like numbers refer to like elements throughout the specification.

It will be understood that, although the terms “first”, “second”, etc. are used herein to describe various elements, these elements should not be limited by these terms. These terms are used to distinguish one element from another. For example, a “first” element could be termed a “second” element, and, similarly, a “second” element could be termed a “first” element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements can be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). When an element is referred to herein as being “over” another element, it can be over or under the other element, and either directly coupled to the other element, or intervening elements may be present, or the elements may be spaced apart by a void or gap.

The terminology used herein is for the purpose of describing particular embodiments and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

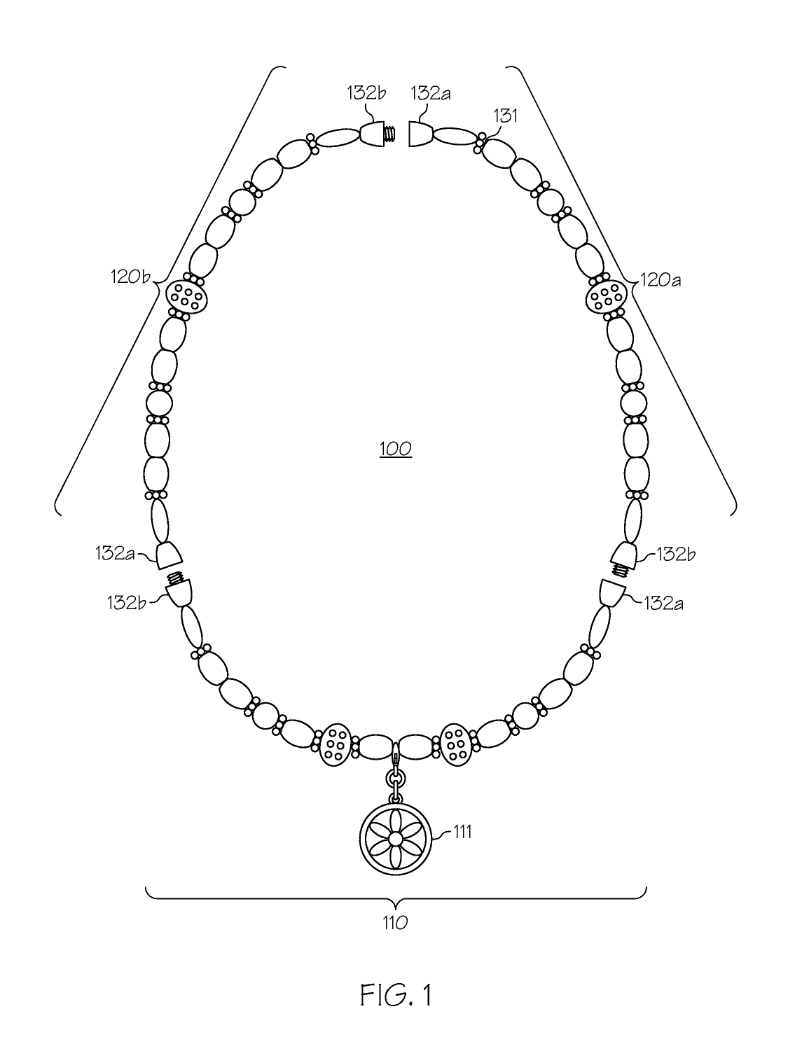

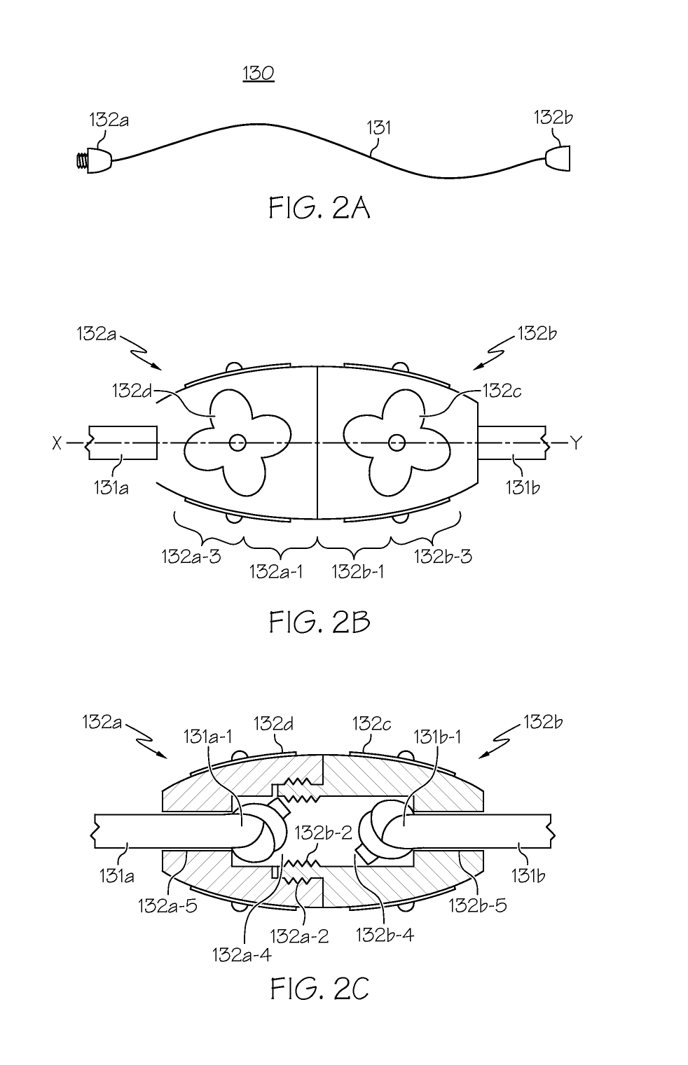

FIG. 1 is a schematic illustration of a jewelry system 100 in accordance with an embodiment. The jewelry system 100 comprises a main strand 110, a first harmonizing strand 120a, and a second harmonizing strand 120b (collectively referred to herein as harmonizing strands 120). The main strand 110 and harmonizing strands 120 are interconnected with one another by inter-engaging end clasps 132a, 132b that are present on each strand 110, 120. In some embodiments, the end clasps 132a, 132b can be positioned at ends of the strands 110, 120 as shown in the embodiments of FIGS. 2B and 2C, described in further detail below. In other embodiments, the end clasps 132a, 132b can be positioned at intermediate locations on the strands 110, 120 near the ends of the strands 110, 120, or at intermediate locations on the strands 110, 120 near center portions of the strands 110, 120.

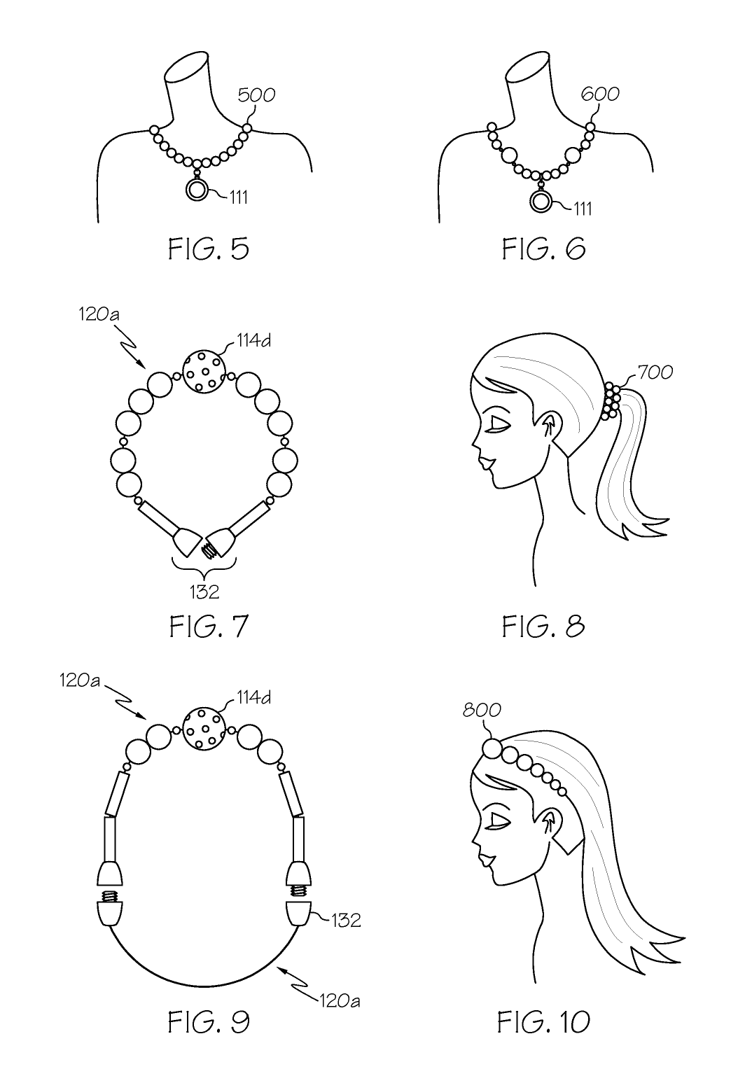

In various embodiments, the strands 110, 120 can be connected to each other to form a jewelry system 100 that includes the main strand 110 and both the first and second harmonizing strands 120a, 120b. Alternatively, the strands 110, 120 can be connected to each other to form a jewelry system 100 that includes the main strand 110 and one of the first and second harmonizing strands 120a, 120b. Alternatively, the strands 110, 120 can be connected to each other to form a jewelry system 100 that includes the first harmonizing strand 120a and the second harmonizing strand 120b. Alternatively, each strand 110, 120 can be selectively disconnected, and used as a single piece of jewelry as shown in the embodiments of FIGS. 5 and 7. It should be noted that even though the jewelry system 100 is illustrated as including two harmonizing strands 120a, 120b, this is for illustrative purposes only, and the jewelry system 100 can include more than two harmonizing strands 120, or a single harmonizing strand 120 in accordance with the technical aspects of the present inventive concepts.

An illustrative embodiment of a system 100 including a main strand 110 and a single harmonizing strand 120 is depicted in FIGS. 21, 22, and 23. The same principles of the above dual-harmonizing-strand embodiment as depicted herein as least in connection with FIGS. 1, 3, and 4, apply equally well to the present single-harmonizing-strand embodiment, and are not repeated here for the sake of brevity.

In any or all of the above embodiments, components of the jewelry system 100 are modular so that the various strands are conducive for collecting and trading among members of a social category or environment. In one embodiment, the end-clasps 132a, 132b of different strands of different jewelry systems are compatible with each other so that the components of a first jewelry system 100 can be exchanged with components of a second jewelry system 100. The first and second jewelry systems 100 can each contain beads having unique patterns or indicia; therefore, when their components are exchanged, the recipient of a component can integrate the different pattern or indicia of a donor into her jewelry system.

In one example, the main strand 110 of a first jewelry system 100 can be coupled to the first and second harmonizing strands 120a, 120b of a second jewelry system 100 to form a necklace that includes the strands from the different systems. Alternatively, the first harmonizing strand 120a of a first jewelry system 100 can be coupled to a main strand 110 of a second jewelry system 100 to form a choker that includes the strands from the different systems.

In use, one of the harmonizing strands 120a, 120b can be disconnected from the jewelry system 100 by separating the strand from the system at its end clasps. When two individuals, each in possession of her own jewelry system 100, desire to exchange one of their harmonizing strands 120, they can each separate or disconnect one of the harmonizing strands 120 from her jewelry system by opening its end clasps. The individual can then connect and integrate the other person's harmonizing strand to her own jewelry system.

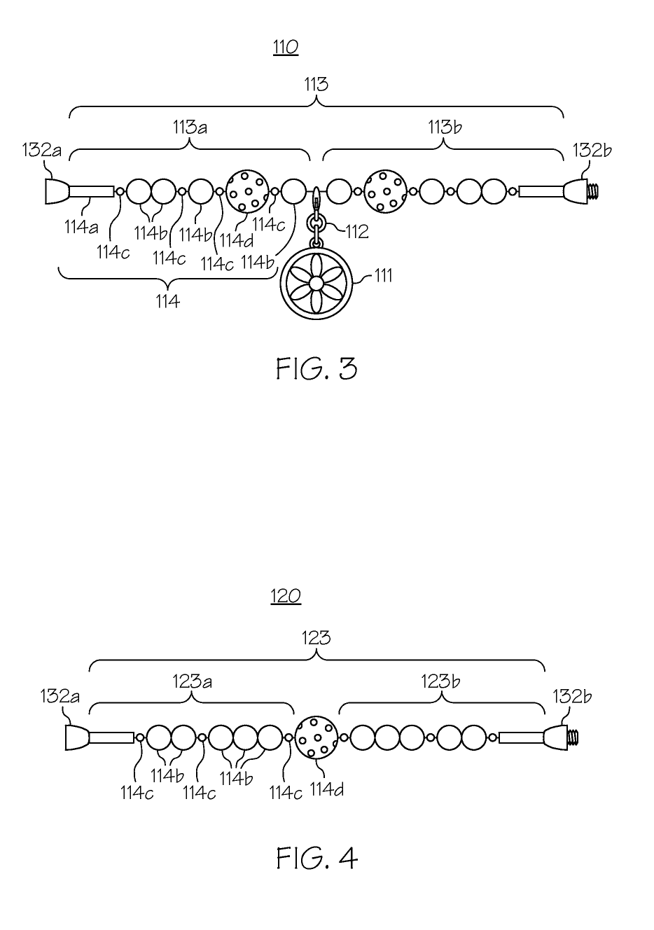

FIG. 2A is a schematic illustration of a frame 130 on which various kinds of beads can be strung, suitable for the main strand and the harmonizing strand as shown in FIG. 3 and FIG. 4, respectively, in accordance with an embodiment. The frame 130 comprises a male end clasp 132a, a female end clasp 132b (collectively referred to herein as end clasps 132), and a supporting string 131 between them. The supporting string 131 can comprise an elastic cord on which various kinds of beads can be strung for aesthetic effects. In one embodiment, the supporting string 131 can comprise an elastic cord having a diameter of about 1.0-1.5 mm. The elasticity of the supporting string 131 can be sufficient to enable the supporting string 131 to expand so that the strands 110, 120, or their interconnected assemblies, can be readily placed on and taken off an individual, for example, stretching over the individual's head for positioning about the individual's neck. In alternative embodiments, the supporting string 131 can comprise an inelastic cord, such as a wire, woven cable, or other inelastic cordage suitable for such an application. In other embodiments, some of the components, for example, the main strand 110 can include an inelastic string 131, while other components, for example, one or more of the harmonizing strands 120 can include an elastic string. In some embodiments the supporting string 131 for the frame 130 of the main strand 110 can be of a length ranging between about 6 inches to about 9 inches. In some embodiments the supporting string 131 for the frame 130 of the main strand 110 can be of a length ranging between about 7 inches to about 8 inches. In some embodiments the supporting string 131 for the frame 130 of the main strand 110 can be of a length of about 7.5 inches. In some embodiments the supporting string 131 for the frame 130 of the harmonizing strand 120 can be of a length ranging between about 5 inches to about 8 inches. In some embodiments the supporting string 131 for the frame 130 of the harmonizing strand 120 can be of a length ranging between about 6 inches to about 7 inches. In some embodiments the supporting string 131 for the frame 130 of the harmonizing strand 120 can be of a length of about 6.5 inches

In certain embodiments, the frame 130, can be configured to be absent of beads or other indicia, and worn in the system, for example, connected with a main strand 110 or with a harmonizing strand 120a as shown in the embodiment of FIG. 9.

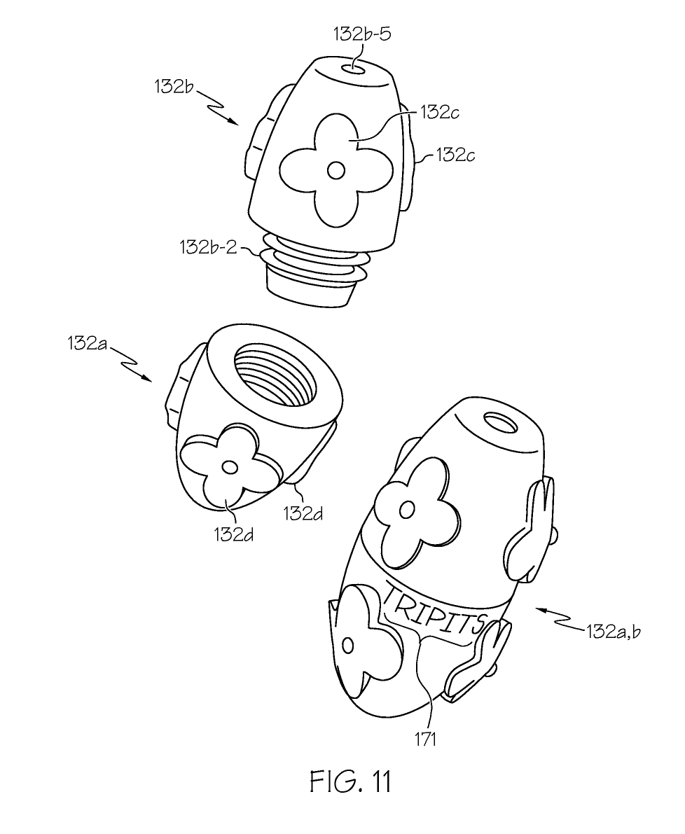

Referring FIGS. 2B and 2C, an embodiments of the end clasps 132 will now be described in further detail. FIG. 2B is a plan view illustration of the inter-engaged state of a male end clasp 132a and a female end clasp 132b, in accordance with an embodiment of the present inventive concepts. FIG. 11 is a perspective view of an embodiment of the end clasps, in accordance with the present inventive concepts.

FIG. 2B shows a plan view of the inter-engaged state of the male end clasp 132a and the female end clasp 132b. FIG. 2C shows a cross-sectional view taken at line X-Y of FIG. 2B.

The male end clasp 132b can comprise a first barrel-shaped portion 132b-1, a first end of which includes an male thread 132b-2 and a second end of which includes a first conical shaped portion 132b-3. The male end clasp 132b further comprises a first chamber 132b-4 with a first opening 132b-5 at which a supporting string 131b can be connected. In one embodiment, the chamber 132b-4 is of a size so as to accommodate a knotted end 131b-1 of the supporting string 131. In one embodiment, the volume of the chamber is sufficient to allow for the knotted end 131b-1 to readily turn or spin within the chamber 132b-4 so to avoid the build-up of winding torsion in the supporting string 131, which otherwise could eventually cause breakdown of the supporting cord 131b. The knotted end 131b-1 of the supporting string 131 has a diameter larger than that of the first opening 132b-5, so that when outward tension is placed on the supporting string 131b, the entrance portion of narrowed opening 132b-5 operates as a block to prevent the supporting string 131b from being pulled from, or otherwise separated from, the male end clasp 132b. In other embodiments, the knotted end 131b-1 of the supporting string 131 can be crimped or otherwise held in the chamber 132b-4 of the clasp 132b.

The female end clasp 132a can comprise a second barrel-shaped portion 132a-1, a first end of which includes a female thread 132a-2 on an inner surface and a second end of which includes a second conical-shaped portion 132a-3. The female end clasp 132a further includes a second chamber 132a-4 with a second opening 132a-5 at which a supporting string 131a can be connected. In one embodiment, the second chamber 132a-4 is of a size so as to accommodate a knotted end 131a-1 of the supporting string 131a. In one embodiment, the volume of the second chamber 132a-4 is sufficient to allow for the knotted end to 131a-1 to readily turn, or spin, within the chamber 132a-4 so to avoid the build-up of winding torsion in the supporting string 131, which otherwise could eventually cause breakdown of the supporting cord 131a. The knotted end 131a-1 of the supporting string 131 has a diameter larger than that of the second opening 132a-5, so that outward tension is placed on the supporting string 131a, the entrance portion of the narrowed opening 132a-5 operates as a block to prevent the supporting string 131a from being pulled from, or otherwise separated from, the female end clasp 132a. In other embodiments, the knotted end 131a-1 of the supporting string 131 can be crimped or otherwise held in the chamber 132a-4 of the clasp 132a.

Outer surfaces of the female end clasp 132a and male end clasp 132b can further comprise indicia 132c, 132d, such as a descriptive emblem 132c, 132d, or other indicia, that covers a portion of the barrel-shaped body portion 132a-1, 132b-1 and the conical portion 132b-3, 132b-4. In an embodiment, the indicia 132c, 132d, enhances the aesthetics of the strand on which it is mounted. In various embodiments, the indicia can be painted on the surface of the end clasp 132a, 132b, can comprise a label that is applied to the surface of the clasp 132a, 132b, or can otherwise be molded on the surface of the clasp 132a, 132b. In other embodiments, the indicia 132c, 132d can be raised above the surface of the clasp 132a,132b to provide a gripping surface. In one embodiment, the indicia 132c, 132d can comprise a flower, animal, symbol, or other unique shape, pattern or color. As shown in FIG. 11, in some embodiments, textual indicia 171 can be provided on an exterior surface of at least one of the female end clasp 132 and/or male end clasp 132b. The textual indicia 171 can indicate any of a number of types of information, including, but not limited to, the manufacturer of the system 100, the seller of the system 100, the individual owner of that particular system 100, a slogan related to the theme of that particular system 100, inspirational messages or expressions corresponding to the theme of the system 100, serial numbers of the system 100, and other suitable forms of textual information.

The female end clasp 132a generally has the same appearance as that of the male end clasp, as shown in FIG. 2B. In one embodiment, both end clasps 132a, 132b of the same, common frame 130 have the same outer dimensions and the same indicia 132c, 132d on their outer surfaces. Further, in other embodiments, the end clasps 132a, 132b can have a plurality of indicia 132c, 132d positioned on their outer surfaces. The indicia 132c, 132d on mating end clasps 132a, 132b can be positioned to be symmetric at a position where the corresponding end clasps 132a, 132b are completely inter-engaged as shown in FIGS. 2B and 2C. In other embodiments, end clasps 132a, 132b of different frames 130 of different systems can have different indicia 132c, 132d on their outer surfaces. Such differences between systems can promote collecting by an individual owner of multiple systems, and promote exchange between owners of different systems.

FIG. 11 is a perspective view of an embodiment of the end clasps 132a, 132b. To attach the end clasps 132a, 132b to mating clasps, the male end clasp 132b can be rotated clockwise relative to the female end clasp 132a to completely inter-engage the screw threads 132a-2, 132b-2 of the end clasps 132a, 132b. In one embodiment, the end clasps 132a, 132b have raised emblems 132c, 132d on their respective surfaces, so that the end clasps 132a, 132b can be readily gripped and can be readily rotated to close the main strand 110 on itself. For removal, the end clasps 132a, 132b can be readily opened by using the raised emblems 132c, 132d on the surface of the end clasps 132a, 132b as a gripping surface.

Various types of beads, decorative spacers, and other novelties, can be strung on the supporting string 131 of a strand 130, forming a bead pattern between the female end clasp 132a and the male end clasp 132b of a strand, thereby enhancing the aesthetics of the strands 110, 120. Referring to FIG. 3 and FIG. 4, illustrative embodiments of the main strand 110 and the harmonizing strands 120 will now be explained in further detail.

FIG. 3 is a schematic illustration of a main strand 110 in accordance with an embodiment. In this example, the main strand 110 comprises a pendant 111 attached to the main strand by a pendant clasp 112 positioned at the center position of the main strand 110.

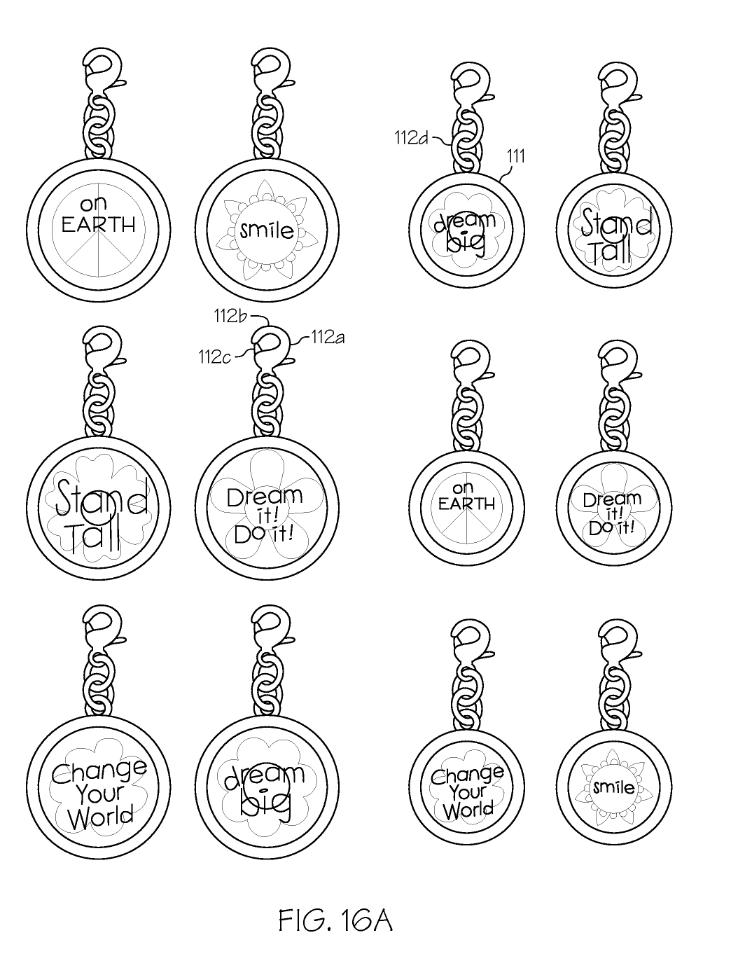

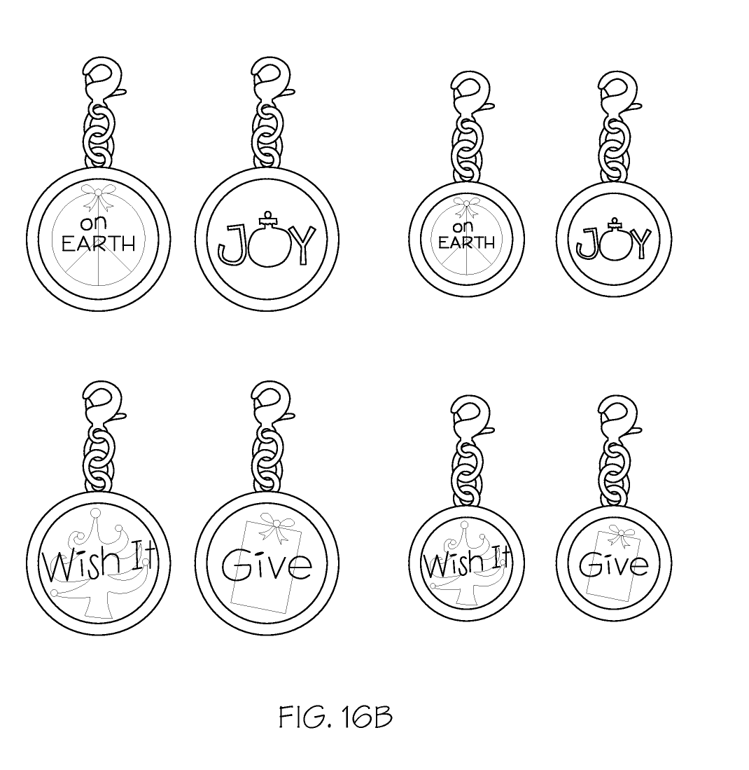

In one embodiment, the pendant clasp 112 can comprise a clasping device that that is suitable for attaching the pendant 111 to the main strand 110. In another embodiment, the pendant clasp 112 can comprise a clasping device that that is suitable for removably attaching the pendant 111 to the main strand 110, to that the pendant can be readily removed from and attached to the main strand. In one embodiment, the pendant clasp can comprise a clasping device that is integral with the body of the pendant, so that the pendant 111 is self-clasping to the main strand 110 or harmonizing strand. In some embodiments, the pendant 111 body comprises metal alloy, stainless steel, molded plastic, glass, wood, or other suitable material. An artistic insert containing the inspirational expression can be inserted or otherwise bonded to the pendant body, and a clear plastic or glass cover can be mounted on the artistic insert. In one embodiment, the pendant clasp 112 comprises metal alloy, stainless steel, molded plastic, glass, wood, or other suitable material. In some embodiments, the pendant clasp 112 can comprise a spring-loaded clasp 112c with a hook 112b, for example, of the type 112 illustrated in FIG. 16A. In some embodiments, the pendant clasp 112 can be linked to the pendant 111 body by a chain of links 112d. In some embodiments, the pendant clasp 112 can comprise the female end clasp 132a and male end clasp 132b described above. Such a removable, clasping, pendant 111 promotes collecting of pendants by an individual owner of multiple systems, and promotes exchange of pendants between owners of different systems so that others' pendants can be integrated into an individuals' system.

In this illustrative embodiment, the main strand 110 further comprises a first bead pattern 113a and a second bead pattern 113b. The second bead pattern 113b can be a mirrored pattern of the first pattern 113a at each side of the pendant position 111. In this embodiment, the first bead pattern 113a is between the female end clasp 132a and the pendant clasp 112, and the second bead pattern 113b is between the male end clasp 132b and the pendant clasp 112. In this example, the bead patterns 113a, 113b comprise one or more unity beads 114a, one or more accent beads 114b, and spacer bead 114c and a signature bead 114d, collectively referred to as decorating beads 114. The decorating beads 114 can include string holes, through which the supporting string 131 can be threaded to hold secure the first bead pattern 113a and the second bead pattern 113b.

In some embodiments, the pendant 112 is positioned on the main strand 110 between the first bead pattern 113a and the second bead pattern 113b so that it attaches to the main strand 110 at a position that is approximately at one-half the distance between the end clasps 132a, 132b, or, in other words, substantially at a mid-position of the main strand 110. In some embodiments, first and second signature beads 114d of the main strand 110 lie at positions left and right of the pendant position. In some embodiments, first and second accent beads 114b are positioned between the first and second signature beads 114d, respectively, and the pendant 111. In some embodiments, first and second spacer beads 114c are positioned between the first and second signature beads 114d, respectively, and the pendant 111. In some embodiments, first and second spacer beads 114c and first and second accent beads 114b are positioned between the first and second signature beads 114d, respectively, and the pendant 111.

In various embodiments, the decorating beads 114 can comprise various colors, geometrical shapes, and sizes. In one embodiment, the unity bead 114a can be configured in a long tubular or cylindrical shape, the accent bead 114b can be configured in a ball, ellipsoidal or spherical shape, and the spacer 114c can also be configured in a ball shape or in a three-dimensional geometric shape such as a flower. In some embodiments, the spacer beads 114c are smaller than the accent beads 114b. In one embodiment, any or all of the decorating beads 114 can comprise pewter. In other embodiments, the decorating beads 114 can comprise any of a number of suitable materials, for example glass, plastic, metal, metal alloy, or wood. In some embodiments, the signature bead 114d, can be configured in a coin shape with an identifying mark, for example, a character, a symbol, a graphical image, an inspirational saying or term, or any geometric shape, on its face to represent an original holder of the main strand 110. In other embodiments, the signature bead 114d can be configured in a three-dimensional geometric shape such as a sphere or cube, or as an object such as an animal or flower. Also, in some embodiments, the pendant can likewise be configured in a coin shape or other geometric shape with an identifying mark, for example, a character, a symbol, a graphical image, an inspirational expression or term, on its face to represent an original holder of the main strand 110. In other embodiments, the signature bead 114d can be configured in a three-dimensional geometric shape such as a sphere or cube, or as an object such as an animal or flower. The other beads 114 and the pendant 111 can be configured in a similar manner. The bead patterns 113a, 113b, can be configured in various ways by changing the type of beads, the number of beads, or both, selected among the decorating beads 114.

FIG. 4 is a schematic illustration of a harmonizing strand 120 in accordance with an embodiment of the present invention. In one embodiment, the harmonizing strand 120 can comprise a collection of the decorating beads 114, in the manner described above in connection with the main strand 110. The decorating beads 114 can be patterned in various ways by changing the type of beads, the number of beads, or both, selected among the decorating beads 114.

In this embodiment, the harmonizing strand 120 comprises a third bead pattern 123a and a fourth bead pattern 123b. In one embodiment, a signature bead 114d can be positioned at the center of the harmonizing strand 120a between the third bead pattern 123a and the fourth bead pattern 123b so that the third bead pattern 123a is provided between the female end clasp 132a and the signature bead 114d, and the fourth bead pattern 123b is provided between the male end clasp 132b and the signature bead 114d. In this example embodiment, the fourth bead pattern 123b is a mirrored pattern of the third pattern 123a. In one embodiment, the third and fourth bead patterns 123a, 123b can comprise one or more of the unity bead 114a, the spacer 114b, and the accent bead 114c. Alternatively, one or more signature beads 114d can be included in the patterns 123a, 123b. Other types of beads 114e can also be included on the harmonizing strand, as described above in connection with the main strand 110.

In some embodiments, the signature bead 114d of the system 100 is positioned on the harmonizing strand 120 between the third bead pattern 123a and the fourth bead pattern 123b so that it lies at a position that is approximately at one-half the distance between the end clasps 132a, 132b, or, in other words, substantially at a mid-position, of the harmonizing strand 120. In some embodiments, at least one first and second accent beads 114a are positioned to the left and right of the central signature bead 114d at the mid-point of the harmonizing strand 120. In some embodiments, at least one first and second spacer beads 114c are positioned to the left and right of the central signature bead 114d at the mid-point of the harmonizing strand 120.

In use, the jewelry system 100 can be worn in a variety of ways. For example, the system 100 can be worn as a one-piece or two-piece choker with pendant as shown in FIG. 5, a one-piece or two-piece choker without a pendant, a three-piece necklace with a pendant as shown in FIG. 6, a three-piece necklace without a pendant, a one-piece bracelet, anklet or ponytail holder as shown in FIGS. 7 and 8, and a headband with an elastic strap as shown in FIG. 9 and FIG. 10. The end clasps 132a, 132b of each strand 110, 120 can be readily attached to each other to connect strands 110, 120 in serial fashion, or can be readily unattached so as to disconnect strands 110, 120 in order to reconfigure the jewelry system 100. In addition, in a case where the supporting string 131 of one or more strands is elastic, the thus-configured jewelry system 100 can be readily placed on and removed from an individual's neck over the head of the individual.

FIG. 5 is a schematic illustration of a modular jewelry system configured as a choker with pendant 500 as worn around an individual's neck. In one embodiment, a one-piece or two-piece choker with pendant 500 can comprise a main strand 110 of a system 100. The main strand 110 can be closed on itself by connecting the male end clasp 132a and the female end clasp 132b of the main strand 110. In another embodiment, a two-piece choker with pendant 500 can comprise a main strand 110 and a harmonizing strand 120 of a system 100. The elasticity of the supporting string 131 of the main strand 110 or the harmonizing strand or strands 120 allows for stretch in the choker 500 so that it can be readily placed on and removed from an individual. In alternative embodiments, a choker without a pendant can be implemented by using one or more harmonizing strands 120a in the manner explained above.

FIG. 6 is a schematic drawing of a modular jewelry system configured as a necklace with pendant 600 worn around an individual's neck. In one embodiment, the necklace 600 can comprise one or more of the strands of a system 100: a main strand 110, a first harmonizing strand 120a, and a second harmonizing strand 120b as shown in FIG. 1. A male clasp 132b of each strand 110, 120 can be connected to a female clasp 132a of another adjacent strand to form the necklace 600. For example, the male clasp 132b of the male strand 110 can be connected to the female clasp 132a of the first harmonizing strand 120a. In turn, the male clasp 132b of the first harmonizing strand 120a can be connected to the female clasp 132a of the second harmonizing strand 120b. Then, the male clasp 132b of the second harmonizing strand 120b can be connected to the female clasp 132a of the main strand 110. The elasticity of the supporting string 131 of the strands 110, 120 of the jewelry system 100 allows for the necklace 600 to be put on and taken off with ease. In alternative embodiments, a three-piece necklace without a pendant can be implemented by interconnecting a plurality of harmonizing strands 120, or a plurality of main strands 110 without pendants, in the manner explained above.

FIG. 7 is a schematic illustration of a modular jewelry system configured as a pony-tail holder, in accordance with an embodiment. FIG. 8 is a schematic illustration of a pony-tail holder of the type shown in FIG. 7 being worn by an individual, in accordance with an embodiment.

Referring to FIGS. 7 and 8, a shorter segment of one or more harmonizing strands 120a, 120b or one or more main strands 110 can be implemented as one of a bracelet, anklet or ponytail holder 700. For the convenience of explanation, a ponytail holder will explained as an exemplary embodiment. The ponytail holder can be used as bracelet or anklet without adjusting the ponytail holder.

In one embodiment, the harmonizing strand 120a of a system has a length so that a single segment is suitable for use as a ponytail holder 700. The harmonizing strand 120a can be closed on itself by connecting the male end clasp 132a and the female end clasp 132b of the harmonizing strand 120a. The male end clasp 132b can be rotated clockwise relative to the female end clasp 132a to completely inter-engage the screw threads 132a-2, 132b-2 of the end clasps 132a, 132b. As described above, the end clasps 132a, 132b can have raised emblems 132c, 132d on their surface, so that the end clasps 132a, 132b can be readily gripped and can be readily rotated to close the harmonizing strand 120a. For removal, the end clasps 132a, 132b can be readily opened by using the raised emblem 132c, 132d on the surface of the end clasps 132a, 132b. The elasticity of the supporting string 131 of the harmonizing strand 120a allows for the ponytail holder 700 to be put on and taken off with ease.

FIG. 9 is a schematic illustration of a modular jewelry system configured as a headband, in accordance with an embodiment. FIG. 10 is a schematic illustration of the headband of the type shown in FIG. 9 being worn by an individual, in accordance with an embodiment.

Referring to FIGS. 9 and 10, a longer segment of one or more harmonizing strands 120a, 120b or one or more main strands 110 can be implemented as a headband 800. In one embodiment, the headband 800 can be implemented by a single piece of a harmonizing strand 120a and a beadless frame 130. In one embodiment, the harmonizing strand 120a can be connected to the frame 130 by connecting the respective end clasps 132a, 132b of the harmonizing strand 120a and the frame 130. For example, the male end clasp 132b of the harmonizing strand 120a can be connected to the female end clasp 132a of the frame 130. In turn, the male end clasp 132b of the frame 130 can be connected to the female end clasp 132a of the harmonizing strand 120a. The male end clasp 132b can be rotated clockwise relative to the female end clasp 132b to completely inter-engage the screw threads 132a-2, 132b-2 of the each end clasp 132a, 132b. As described above, the end clasps 132a, 132b can have raised emblems 132c, 132d on their surface, so that the end clasps 132a, 132b can be readily gripped and can be readily rotated to close the head band 800. For removal, the end clasps 132a, 132b can be readily opened by using the raised emblems 132c, 132d on the surface of the end clasps 132a, 132b. The elasticity of the supporting string 131 of the harmonizing strand 120a and the frame 130 allow for the head band 800 to be put on and taken off with ease.

In the embodiments disclosed herein, the main strand 110 and the harmonizing strands 120 are of a length so that, when used individually, or in combination, they provide an appropriate fit to the individual wearing them. If the system is to be configured for an adult, the length of the main strand 110 and the harmonizing strands 120 can be greater than the length of the main strand 110 and the harmonizing strands 120 for a system that is to be configured for a child. Alternatively, further harmonizing strands 120 or main strands 110 can be added to a system to increase the length so that it can be worn by an adult.

In other embodiments, the main strand 110 and the first and second harmonizing strands 120a, 120b can be of the same length. Alternatively, the main strand 110 can be of a first length, and the first and second harmonizing strands 120a, 120b can be of a same, second, length that is different than the first length. In one embodiment, the second length can be less than the first length. In another embodiment, the second length can be greater than the first length. Alternatively, the main strand 110 can be of a first length, the first harmonizing strand 120a can be of a second length and the second harmonizing strand 120b can be of a third length, whereby the first, second, and third lengths are different.

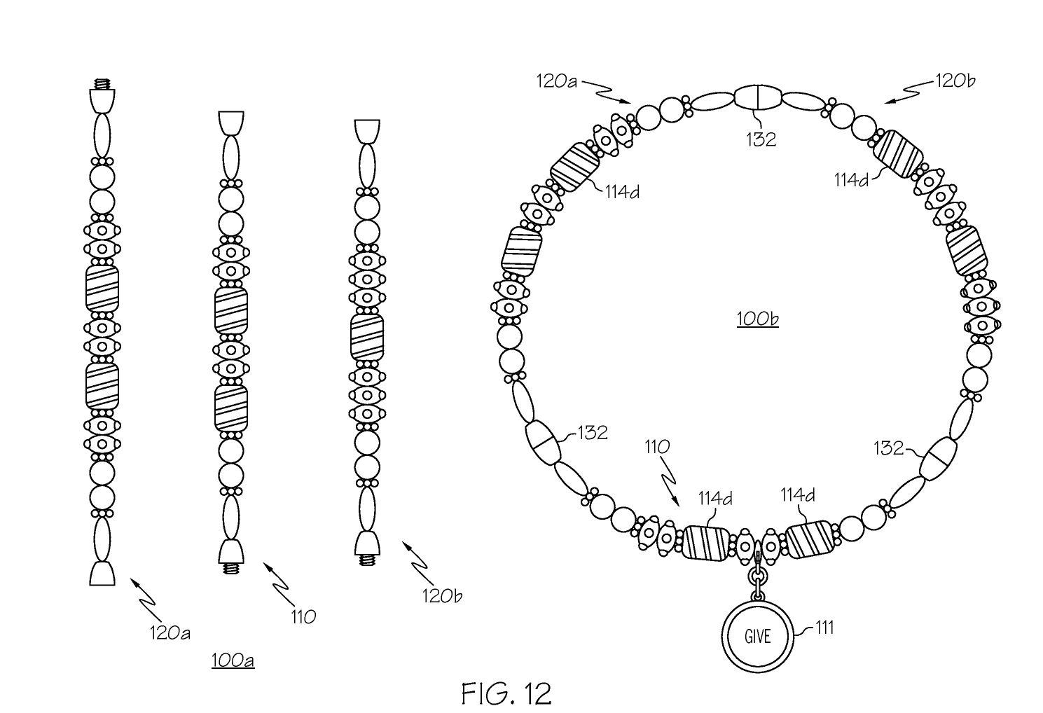

FIGS. 12-20 are images of various configurations of jewelry systems is accordance with various embodiments. In these embodiments, it can be seen that the beads 114 can be of different shapes and of different patterns and colors. It can also be seen that the pendants 111 can include various inspirational expressions such as “Give”, “Dream Big”, and “Peace (symbol) on Earth”.

FIG. 12 includes views of an embodiment of a system 100 illustrating an assembled top view 100b, and including a disassembled side view of the main strand 110 and first and second harmonizing strands 120a, 120b. In the assembled top view 100b, it can be seen that the pendant 111 attached to the main strand 110 includes the inspirational expression “Give”. In the present embodiment of the system 100, the signature beads 114d comprise cylindrical-shaped translucent beads with colored spiral patterns on their exterior bodies. In some embodiments, the colored spiral patterns comprise red spiral patterns.

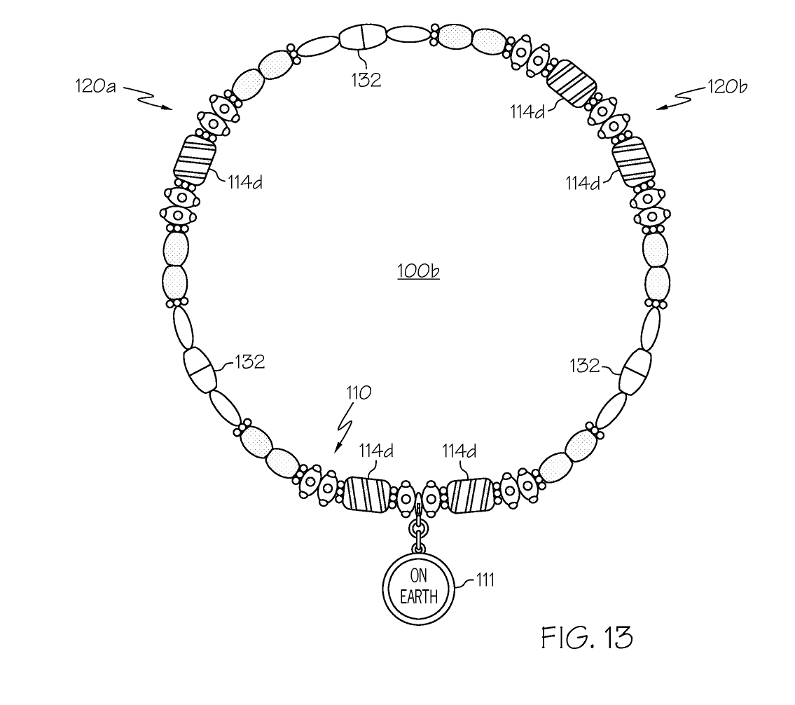

FIG. 13 includes a view of an embodiment of a system 100 illustrating an assembled top view 100b of the main strand 110 and first and second harmonizing strands 120a, 120b. In the assembled top view 100b, it can be seen that the pendant 111 attached to the main strand 110 includes the inspirational expression “Peace (symbol) on Earth”. In the present embodiment of the system 100, the signature beads 114d comprise cylindrical-shaped translucent beads with colored spiral patterns on their exterior bodies. In some embodiments, the colored spiral patterns comprise green spiral patterns.

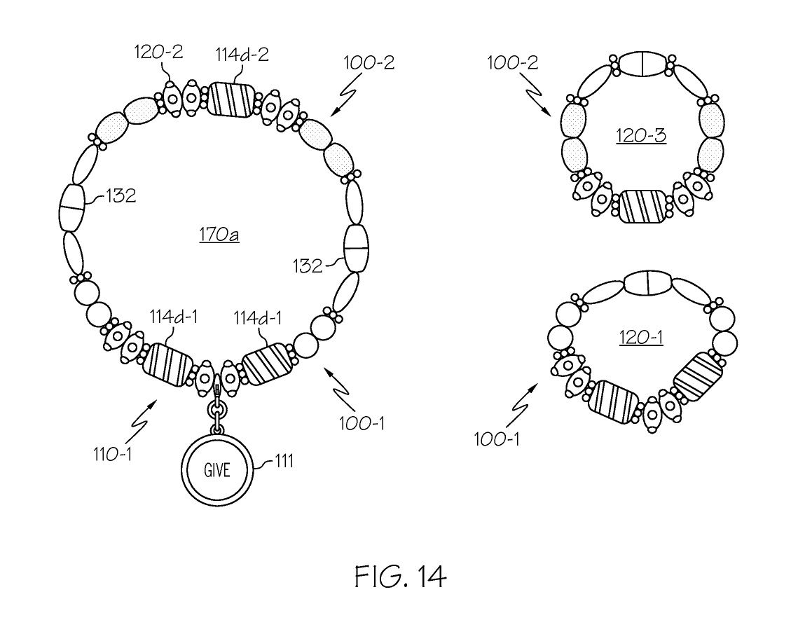

FIG. 14 includes a view of an embodiment of a system 100 illustrating an assembled top view 100b of a main strand 110-1 and a harmonizing strand 120-2. In the assembled top view 100b, it can be seen that the present example embodiment is illustrative of an assembled system that includes components from two different originating systems. The main strand 110-1 originates from a first system 100-1 including the main strand 110-1 and a harmonizing strand 120-1. The harmonizing strand 120-2 originates from a second system 100-2 including the harmonizing strand 120-2 and a second harmonizing strand 120-3. In some embodiments, the first system 100-1 has a first color theme, for example a red color theme. In some embodiments, the second system 100-2 has a second color theme that is different than the first color theme, for example the second system 100-2 can have a green color theme. This embodiment provides an example of the interchangeability of strands or components, such as pendants, from different originating systems 100-1, 100-2.

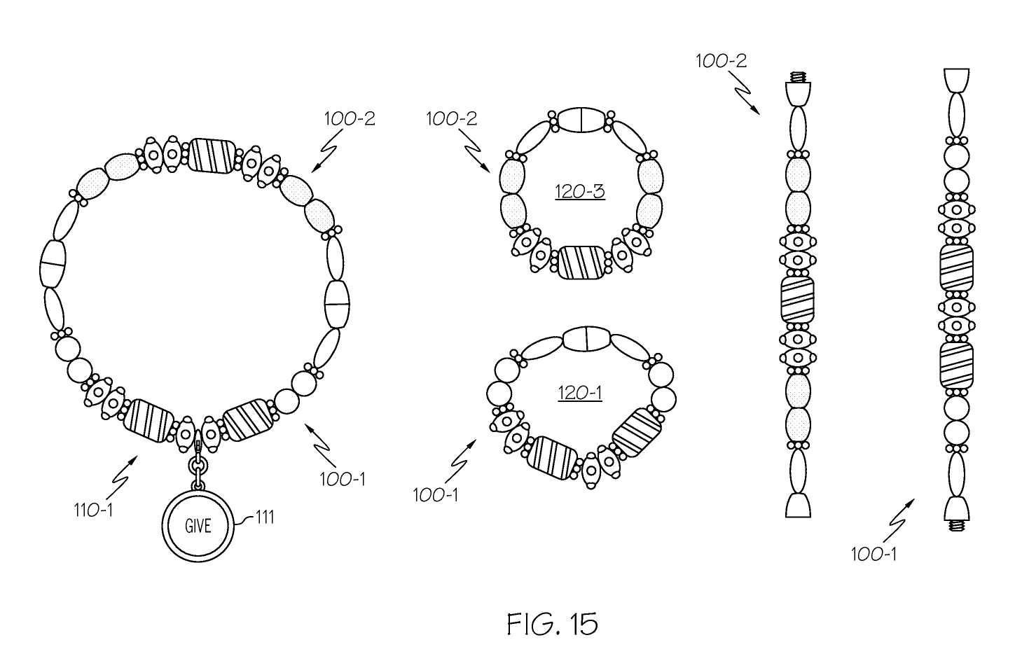

FIG. 15 is a top view of the system of FIG. 14, with each of the first and second systems 100-1, 100-2 illustrated as comprising a main strand and first and second harmonizing strands. In the present example of FIG. 15, each system 100-1, 100-2 includes three strands, wherein in the example of FIG. 14 above, each system includes two strands.

FIGS. 16A and 16B are top views of various pendants 111, each indicating an inspirational expression. For example, the pendants 111 illustrated in FIG. 16A include the following expressions: “Peace (symbol) on Earth”; “Smile”; “Dream Big”; “Stand Tall”; “Dream it! Do it!”; and “Change your World”. The pendants can be formed in relatively different sizes, as shown, depending on the application of the system. As shown in FIG. 16B, the pendants can include a holiday expression as well, such as: “Peace (symbol) on Earth”; “Joy”; “Wish It”; and “Give”.

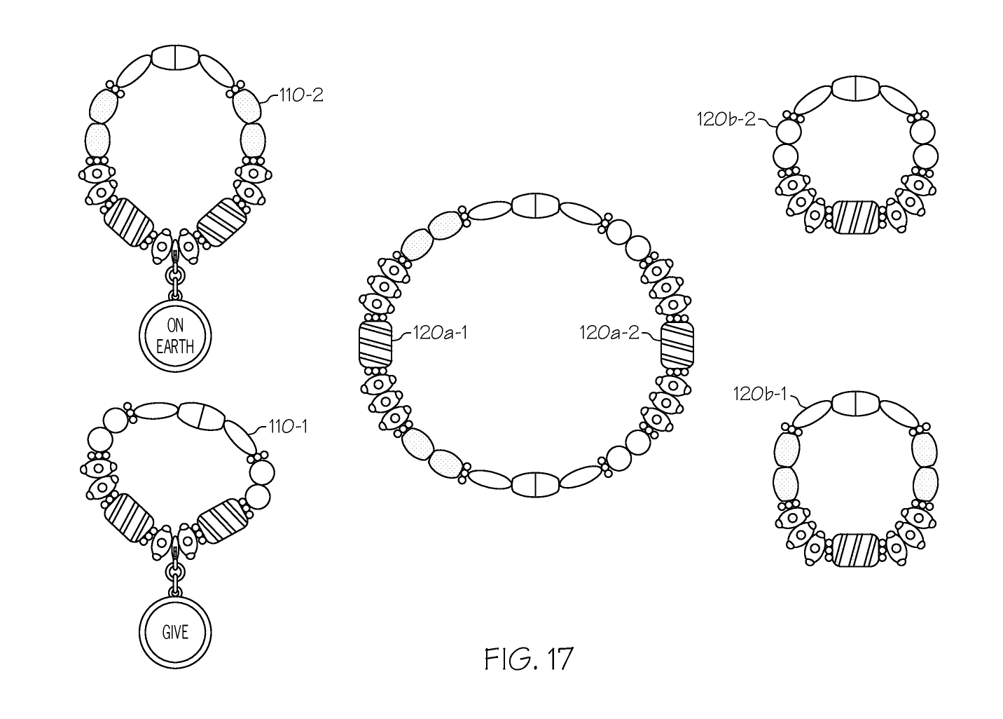

FIG. 17 is a top view of the system of FIG. 15, with each of the first and second systems 100-1, 100-2 illustrated as comprising a main strand and first and second harmonizing strands. In the present example of FIG. 17, each system 100-1, 100-2 includes three strands; however, in the present example, the main strands 110-1, 110-2 are configured as separate bracelets with pendants. First harmonizing strands 120a-1, 120a-2 from each respective system 100-1, 100-2 are combined to form a choker necklace. Second harmonizing strands 120b-1, 120b-2 are configured as separate bracelets or ponytail holders, absent pendants. In some embodiments, the first system 100-1 has a first color theme, for example a red color theme. In some embodiments, the second system 100-2 has a second color theme that is different than the first color theme, for example the second system 100-2 can have a green color theme. This embodiment provides another example of the interchangeability of strands or components, such as pendants, from different originating systems 100-1, 100-2.

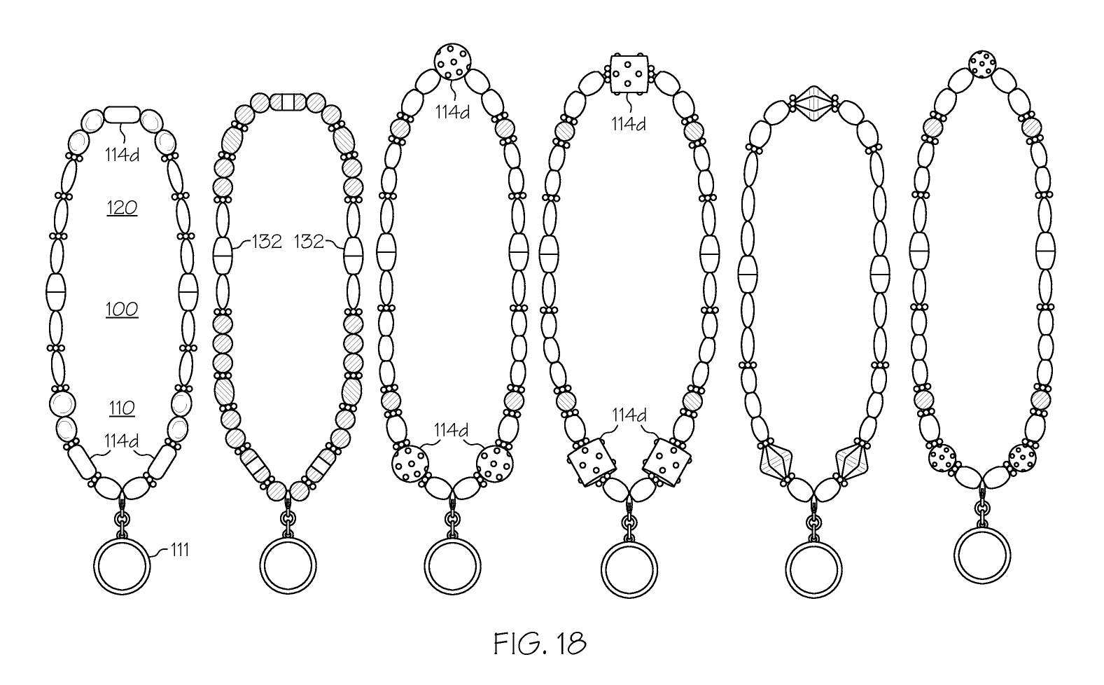

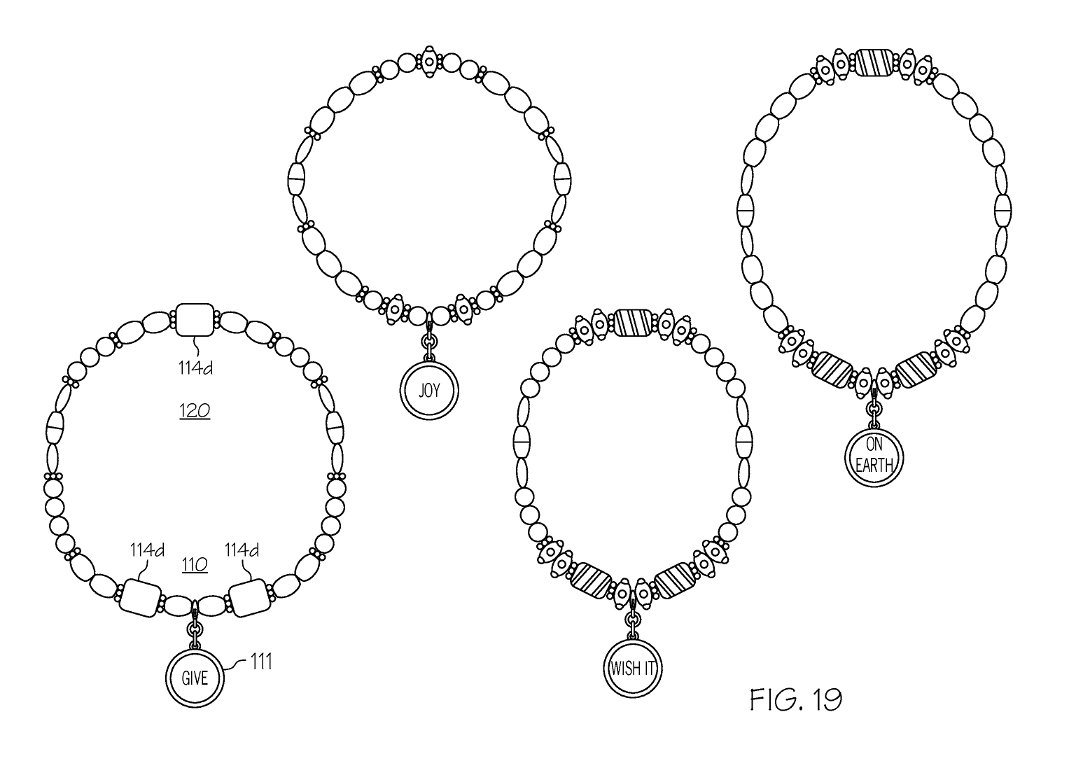

FIGS. 18 and 19 are top views of various systems 100 in accordance with embodiments of the present inventive concepts. In this illustrative embodiment, each system 100 includes a main strand 110 with a pendant 111 positioned at a mid-position of the strand 110, and first and second harmonizing beads 114 to the left and right sides of the pendant 111 position. Each system further includes a harmonizing strand 120 having a harmonizing bead 114 positioned at a mid-position of the strand 110.

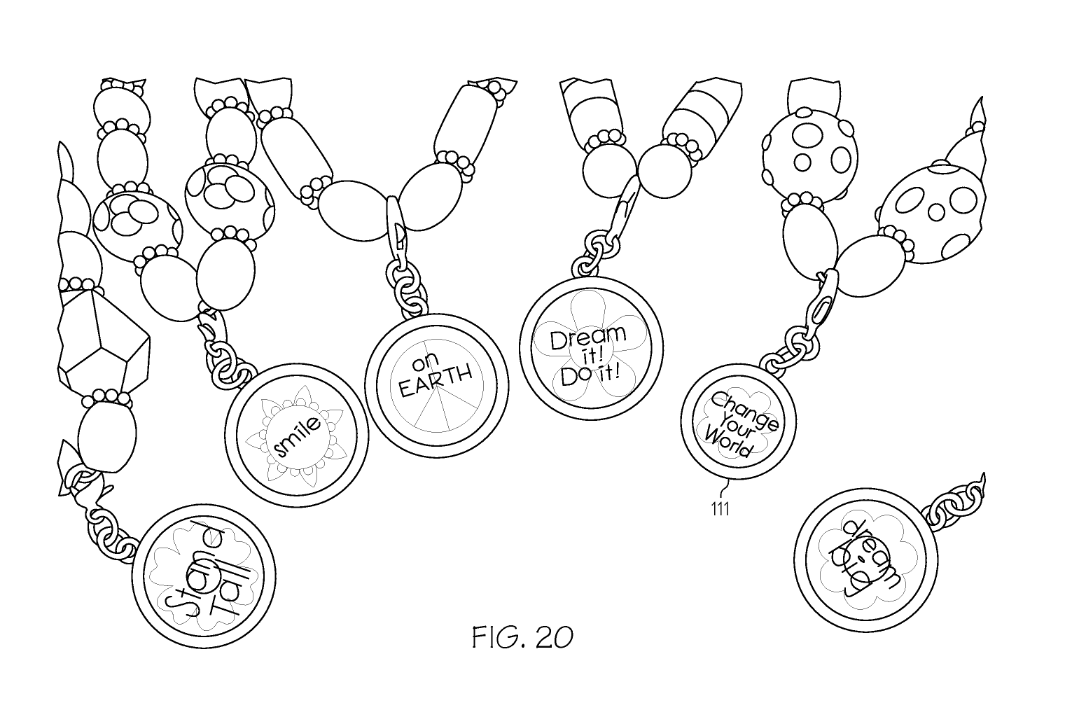

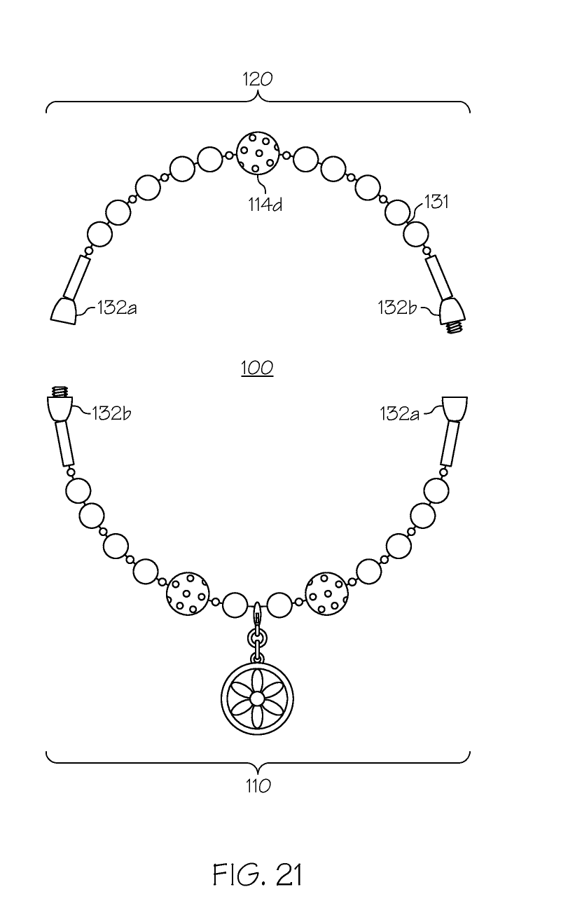

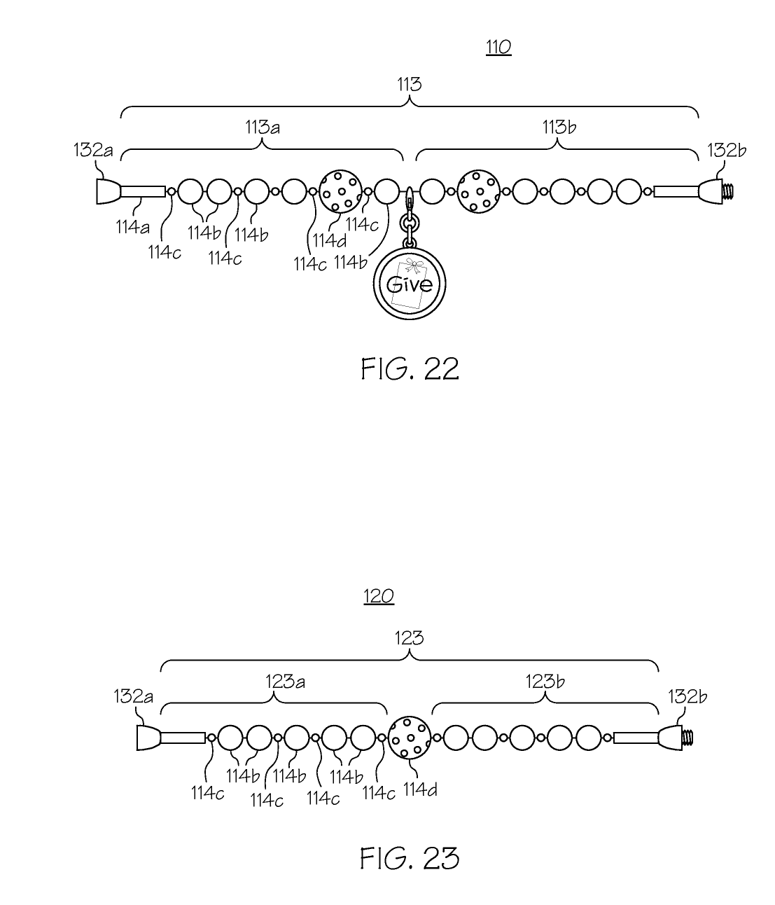

FIG. 20 is a close-up view of the pendants 111 of the main strands of various systems 100 in accordance with embodiments of the present inventive concepts.

In this manner, a modular jewelry system is disclosed herein including multiple modular attachable elements that can be arranged in a variety of configurations. The multiple elements of the jewelry system are conducive for trading and collecting. In particular, the multiple elements of the jewelry system are conducive for trading and collecting among members of a social category or environment.

In one example, the decorating beads 114 can be patterned with indicia and/or expressions and/or color patterns so that they are especially attractive for girls of a particular age group, such as young girls. A first girl can trade portions of her first system with a second girl having a second system. For example, the first girl can remove a first harmonizing strand from her first system, and trade the first harmonizing strand for a second harmonizing strand of the second system owned by the second girl. IN this example, the first and second harmonizing strands may have different types of signature beads, or different types of other beads 114 or clasps 132a, 132b, or different types of indicia on the beads or clasps 132a, 132b. The first and second harmonizing strands can thus be swapped between the first and second girls. Alternatively, pendants of the first and second systems can be swapped by the first and second girls. Further, modular portions of various systems can be exchanged among more than two individuals, thereby creating a trading and collecting community among individuals of a social category, such as age group or other category.

While embodiments of the inventive concept have been particularly shown and described with references to preferred embodiments thereof, it will be understood by those skilled in the art that various changes in form and details may be made herein without departing from the spirit and scope of the inventive concept as defined by the appended claims.

What is claimed is:

1. A jewelry system, comprising:
a main strand having a supporting string, a first clasp at a first end of the supporting string and a second clasp at a second end of the supporting string opposite the first end, the main strand having a first bead pattern between the first clasp and a mid-position of the supporting string and having a second bead pattern between the second clasp and the mid-position of the supporting string, the first bead pattern and the second bead pattern each including at least one signature bead that identifies a theme of the jewelry system; and
at least one harmonizing strand, each of the at least one harmonizing strands having a supporting string, a first clasp at a first end of the supporting string and a second clasp at a second end of the supporting string opposite the first end, the at least one harmonizing strand having a harmonizing bead pattern, the harmonizing bead pattern including at least one signature bead that corresponds to the theme of the jewelry system;
wherein the first and second clasps of the main strand and the at least one harmonizing strand are constructed and arranged so that the first clasp of the main strand can be selectively connected to the second clasp of the at least one harmonizing strand, and so that the second clasp of the main strand can be connected to the first clasp of the at least one harmonizing strand.

2. The jewelry system of claim 1 wherein first and second clasps of the main strand and the harmonizing strand are constructed and arranged so that the first clasp of the main strand can be selectively connected to the second clasp of the main strand, and so that the first clasp of the at least one harmonizing strand can be connected to the second clasp of the at least one harmonizing strand.

3. The jewelry system of claim 1 wherein the first clasp comprises a male clasp and the second clasp comprises a female clasp.

4. The jewelry system of claim 3 wherein the male clasp comprises a male thread and the female clasp comprises a mating female thread.

5. The jewelry system of claim 1 wherein the at least one signature bead of the at least one harmonizing strand comprises a single signature bead that is positioned at a mid-position of the supporting string of the at least one harmonizing strand.

6. The jewelry system of claim 1 wherein the main strand further comprises a pendant positioned at the mid-position of the supporting string of the main strand.

7. The jewelry system of claim 6 wherein the pendant includes indicia that corresponds to the theme of the jewelry system.

8. The jewelry system of claim 7 wherein the indicia comprises an inspirational message.

9. The jewelry system of claim 6 wherein the pendant comprises a clasp that removably secures the pendant to the main strand.

10. The jewelry system of claim 1, wherein each of the first clasps comprises a hollowed body having a male thread projecting therefrom, the hollowed body having an opening extending along a longitudinal axis thereof.

11. The jewelry system of claim 10, wherein each of the second clasps comprises a hollowed body having a female thread portion corresponding to the male thread of the first clasps, the hollowed body having an opening extending along a longitudinal axis thereof.

12. The jewelry system of claim 11 wherein the openings of the hollowed bodies of the female and male clasps each further comprise a chamber that accommodates a knotted end of the supporting string, wherein the chamber is of an inner dimension to permit the knotted end to turn within the chamber.

13. The jewelry system of claim 1, wherein the first and second clasps each comprise indicia on an outer surface thereof.

14. The jewelry system of claim 13, wherein the indicia comprise a raised surface on the outer surface.

15. The jewelry system of claim 1 wherein the supporting string of the main strand and the auxiliary strand is longitudinally elastic.

16. The jewelry system of claim 1 wherein the first and second bead patterns of the main strand further comprise at least one bead selected from the group consisting of: a unity bead, an accent bead, and a spacer bead.

17. The jewelry system of claim 1 wherein the harmonizing beads of a same jewelry system comprise at least one of a substantially similar shape, a substantially similar size and a substantially similar color arrangement, and a substantially similar pattern.

18. The jewelry system of claim 1 wherein the at least one harmonizing strand comprises a single harmonizing strand.

19. The jewelry system of claim 1 wherein the at least one harmonizing strand comprises two harmonizing strands.

20. An interchangeable jewelry system, comprising:
a first jewelry system element comprising:
a main strand having a supporting string, a first clasp at a first end of the supporting string and a second clasp at a second end of the supporting string opposite the first end, the main strand having a first bead pattern between the first clasp and a mid-position of the supporting string and having a second bead pattern between the second clasp and the mid-position of the supporting string, the first bead pattern and the second bead pattern each including at least one signature bead that identifies a first theme of the first jewelry system; and
at least one harmonizing strand, each of the at least one harmonizing strands having a supporting string, a first clasp at a first end of the supporting string and a second clasp at a second end of the supporting string opposite the first end, the at least one harmonizing strand having a harmonizing bead pattern, the harmonizing bead pattern including at least one signature bead that corresponds to the first theme of the first jewelry system element;
wherein the first and second clasps of the main strand and the at least one harmonizing strand are constructed and arranged so that the first clasp of the main strand can be selectively connected to the second clasp of the at least one harmonizing strand, and so that the second clasp of the main strand can be connected to the first clasp of the at least one harmonizing strand; and
a second jewelry system element comprising:
a main strand having a supporting string, a first clasp at a first end of the supporting string and a second clasp at a second end of the supporting string opposite the first end, the main strand having a first bead pattern between the first clasp and a mid-position of the supporting string and having a second bead pattern between the second clasp and the mid-position of the supporting string, the first bead pattern and the second bead pattern each including at least one signature bead that identifies a second theme of the second jewelry system element; and
at least one harmonizing strand, each of the at least one harmonizing strands having a supporting string, a first clasp at a first end of the supporting string and a second clasp at a second end of the supporting string opposite the first end, the at least one harmonizing strand having a harmonizing bead pattern, the harmonizing bead pattern including at least one signature bead that corresponds to the second theme of the second jewelry system;
wherein the first and second clasps of the main strand and the at least one harmonizing strand are constructed and arranged so that the first clasp of the main strand can be selectively connected to the second clasp of the at least one harmonizing strand, and so that the second clasp of the main strand can be connected to the first clasp of the at least one harmonizing strand;
wherein the first and second clasps of the main strand and the at least one harmonizing strand of the first jewelry system element and wherein the first and second clasps of the main strand and the at least one harmonizing strand of the second jewelry system element are constructed and arranged to selectively connect to each other among the first and second jewelry systems so that the main and at least one harmonizing strands of the first and second jewelry system elements are interchangeable.
